(19) United States
(12) Patent Application Publication
(10) Pub. No.: US 2010/0057753 A1
(43) Pub. Date: Mar. 4, 2010

(54) METHODS AND APPARATUS FOR OBTAINING VISUAL INSIGHT PROVENANCE OF A USER

(75) Inventors: David H. Gotz, Purdys, NY (US); Michelle X. Zhou, Briarcliff Manor, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 12/198,964

(22) Filed: Aug. 27, 2008

(51) Int. Cl. G06F 17/30

(52) U.S. Cl. 707/100; 707/200

(57) ABSTRACT

Generally, methods and apparatus are provided for obtaining a user's insight provenance. A logical record of visual analytic activity of a user is maintained by recording one or more visual analytic actions. An exemplary method determines a set of action features of the one or more visual analytic actions; instantiates a data structure to record the action features; calculates a set of operations required to update the logical record based on the determined features; and updates the logical record based on the calculated operations. The visual analytic actions can optionally be classified using a predefined action taxonomy and by recording other action features. A plurality of the data structures can be associated with a node in a trail graph that represents one or more analytical paths of the user.

### FIELD OF THE INVENTION

The present invention relates to data visualization systems and, more particularly, to methods and apparatus for tracking user actions to obtain a user's insight provenance.

### BACKGROUND OF THE INVENTION

In recent years, a large number of visualization systems have been developed to help users view, explore, and analyze information. At the same time, businesses have been creating and storing more data than ever before. Recognizing that valuable insights are buried within these information repositories, companies have begun to push the use of visualization to drive their business decision-making process. Moreover, companies want to empower all of their employees to take part in such a process.

Interactive visual dialog systems aid users in investigating large and complex data sets. There is a large class of users for whom existing tools are of limited value. Many business users, for example, typically have extensive domain knowledge but are not visualization or computer experts. As part of their daily responsibilities, however, they perform situational analysis tasks over large amounts of data.

With most analysis tools, users must go through several steps just to reach the point where the user can actually visualize and explore the project information. The user must first sift through the information to manually extract the information to be visualized, and then the user needs to select a proper visualization to view the extracted data. Thereafter, the user must transform the extracted data into a form that the target visualization tool can take. Finally, the user must repeat all of these steps to continue the analysis if the user decides to examine related information that is not in the originally extracted data set.

As this example illustrates, average users require tools that allow them to perform continuous, situational visual exploration. Few existing systems, however, are designed to support this type of analysis task, especially for the skill set of the average user. The absence of visualization tools suitable for this critical audience may be attributed to a number of challenges. First, it is difficult for a system to predetermine which visualization tools should be offered to users, since the targeted user tasks are often situational and unpredictable. Second, tools must support dynamic and incremental visual updates due to the exploratory and context-sensitive nature of many user tasks. Third, it is difficult for a system to accurately and meaningfully capture a user's insight provenance. Insight provenance refers to the entire history and rationale of how insights are derived, including the relevant user's visual activity, information being explored, and the insight being extracted. Without insight provenance, users would be unable to easily re-use their analytical processes or share their techniques and conclusions with others. Finally, all of the above technical challenges must be addressed without placing any added burden on an average user.

While bookmarks preserve insightful views (e.g., thumbnails and visualization state), they do not capture how the insight was found. Insight provenance, on the other hand, provides a record of how an insight was uncovered. For example, in reaching a business decision, an enterprise may want to know how the analyst get to a particular chart, as well as particular data that was omitted or included.

A need therefore exists for improved methods and apparatus for obtaining a user's insight provenance.

### SUMMARY OF THE INVENTION

Generally, methods and apparatus are provided for obtaining a user's insight provenance. According to one aspect of the invention, a logical record of visual analytic activity of a user is maintained by recording one or more visual analytic actions. An exemplary method determines a set of action features of the one or more visual analytic actions; instantiates a data structure to record the action features; calculates a set of operations required to update the logical record based on the determined features; and updates the logical record based on the calculated operations.

The visual analytic actions can optionally be classified using a predefined action taxonomy and by recording other action features. A plurality of the visual analytic actions can be analyzed to identify a predefined sub-task. The sub-task can comprise a recursive combination of exploration actions and other sub-tasks followed by a combination of insight actions.

According to another aspect of the invention, a plurality of the data structures can be associated with a node in a trail graph that represents one or more analytical paths of the user. The trail graph represents how one or more insights were generated. The trail graph can be updated using the set of calculated operations. The trail graph can optionally be simplified by reducing a complexity of the trail graph. For example, a plurality of neighboring nodes in the trail graph can be contracted into a single node. A portion of a version of the trail graph can be presented as a representation of a logical progress of the user.

Among other benefits, the present invention allows one or more of the visual analytic actions to be undone, modified, deleted and/or revisited.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of a visualization analysis system incorporating features of the present invention;

FIG. 2 is a sample table summarizing a number of exemplary distinct action types;

FIG. 3 illustrates an exemplary taxonomy for classifying user actions;

FIG. 4 is a trail graph representing a user's activity;

FIG. 5 is an exemplary graphical user interface illustrating a user's active trail;

FIG. 6 is a flow chart describing an exemplary implementation of a trail graph maintenance process incorporating features of the present invention;

FIG. 7 is an exemplary graphical user interface illustrating an interactive trail display in accordance with an aspect of the present invention;

FIG. 8 comprises flow charts of exemplary algorithms for asynchronous updates to trail graph nodes for system response and for retrieval of action details;

FIG. 9 is a graphical user interface illustrating an undo functionality in accordance with an embodiment of the present invention;

FIG. 10 is a flow chart describing an exemplary implementation of a bookmark save process;

FIG. 11 is a flow chart describing an exemplary implementation of a bookmark restore process; and

FIG. 12 illustrates a multiple level characterization of user analytic behavior.

### DETAILED DESCRIPTION OF PREFERRED EMBODIMENTS

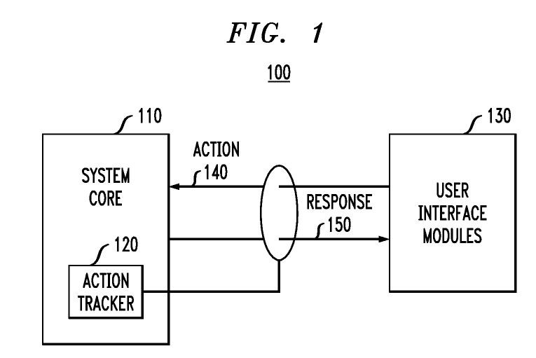

The present invention provides methods and apparatus for obtaining a user's insight provenance. FIG. 1 is a schematic block diagram of a visualization analysis system 100 incorporating features of the present invention. As shown in FIG. 1, the visualization analysis system 100 comprises a system core 110 having an action tracker 120, and one or more user interface modules 130. Generally, the action tracker 120 observes user actions 140 and the corresponding responses 150 of the system. As discussed further below, the action tracker 120 records each incoming action 140 and parameters of key responses 150, such as action type, parameters, time of execution and position in sequence of performed actions.

Multi-Tier Characterization of User Analytic Activity

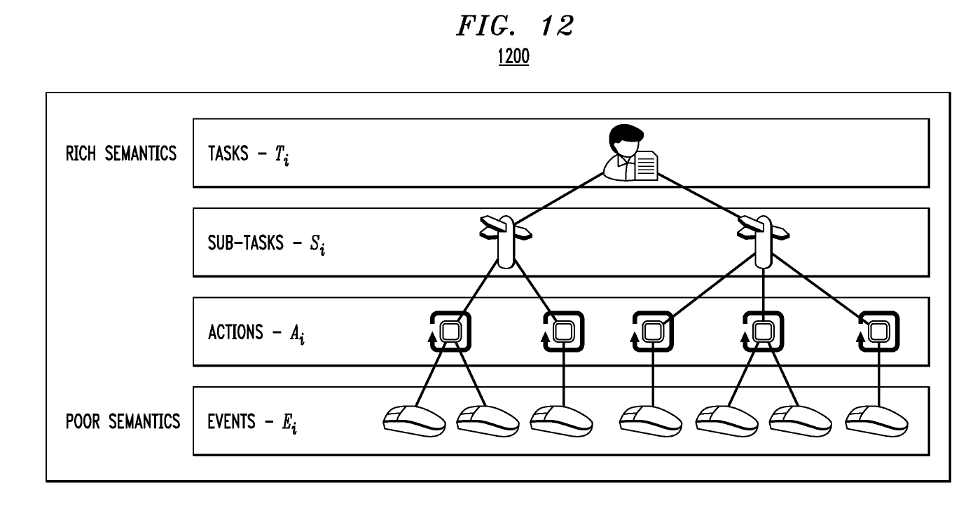

User analytic behavior can be characterized at multiple levels of granularity based on the semantic richness of the activity. FIG. 12 illustrates a multiple level characterization 1200 of user analytic behavior. In particular, an exemplary implementation of the invention shown in FIG. 12 characterizes user visual analytic activity at four levels: tasks, sub-tasks, actions, and events. The top three tiers describe activities that inherently possess some degree of semantics, with tasks as the richest of all tiers. The bottom tier represents the lowest-level user interaction events, such as mouse clicks and key presses, which in isolation typically hold little semantic value.

Consider a stock market analyst, Bob, who is asked to use visualization software to analyze the stock market in order to make investment recommendations in two market sectors: finance and technology.

Tasks: The task tier captures a user's highest-level analytic goals. These goals, which are often open-ended or ambiguous, are what drive a user's overall analysis process. In practice, analysts often juggle multiple tasks at the same time. In the example scenario, Bob has just a single task T1:
T1: Identify key market insights to generate investment recommendations.

Typically, tasks are tightly coupled to the domain or application in which the user is working. For example, while T1 is appropriate for an investment analyst working with financial tools, a travel agent (working with a set of travel and transportation tools) would not likely perform the same task. While tasks vary widely, researchers have developed general taxonomies to help characterize their different types. See, for example, R. Amar and J. Stasko, “A Knowledge Task-Based Framework for Design and Evaluation of Information Visualizations,” Proc. of InfoVis (3004).

Sub-Tasks: The sub-task tier corresponds to more objective, concrete analytic goals. For instance, sub-tasks (noted S1) for T1 in the example scenario might include:
S1: Characterize the overall 52-week market trend in the technology sector.
S2: Identify the best and worst performing financial companies over the last eight weeks.

Analysts typically follow a divide-and-conquer approach, performing several sub-tasks to achieve the requirements of a single top-level task. As in the task tier, sub-tasks are often tightly coupled to the domain or application in which the user is working. For example, S2 is a reasonable sub-task for the investment analyst in our example scenario. However, users in other domains would not likely encounter the same sub-task. Similar to tasks, sub-tasks can also be characterized using existing task taxonomies. See, for example, R. Amar et al., “Low-Level Components of Analytic Activity in Information Visualization,” Proc. of InfoVis 111-117 (2005).

Actions: The third tier in the exemplary characterization of user analytic activity is the action tier. An action is defined as an atomic analytic step performed by a user with a visual analytic system.

Sequences of actions (noted as Ai) can be aggregated to accomplish individual sub-tasks. In the example scenario, Bob might start subtask S2 with the following actions:

A1: Query for eight weeks worth of stock market data.

A2: Split companies by sector.

A3: Filter to show only the financial sector.

A4: Sort companies by their changes in stock price.

A5: Inspect the company with greatest change in stock price to ask for more details such as financial reports.

Unlike the task or sub-task tier, where activity is typically domain or application specific, the action tier is generic. It represents a typical set of user actions that can be performed across different visualization tools and domains. For example, the Query action in A1 can be performed by both financial analysts using stock market visualization tools, and travel agents using their own visualization tools. This contrasts strongly with both T1 and S2, both of which were only appropriate in the investment domain.

While application independent, each action retains a rich level of semantics not found in low-level user-interaction events, such as a mouse click or drag. For example, an isolated click event has little meaning without additional context. In contrast, an action such as Query or Zoom represents a semantically meaningful user activity. Actions, therefore, are unique in that they are both generic with respect to domains and tools, yet semantically rich in terms of user intent.

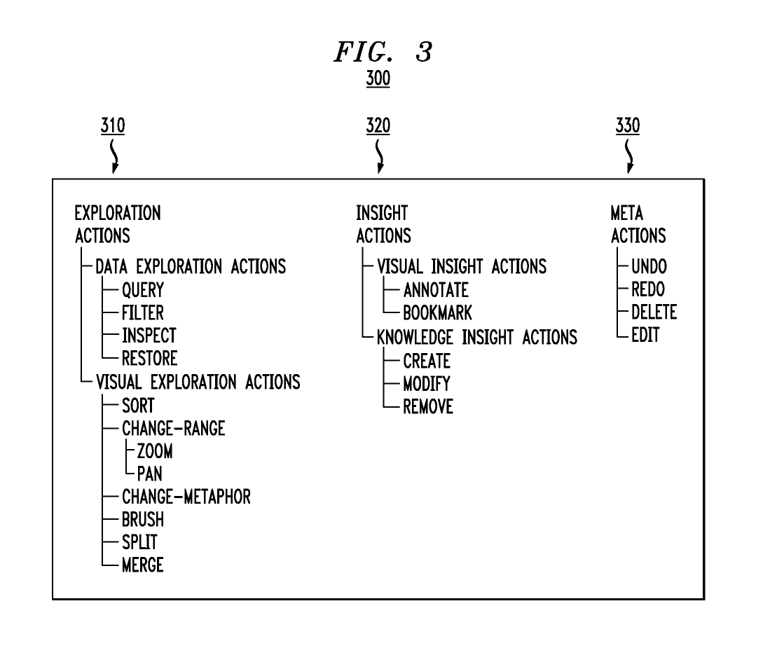

While taxonomies have been developed for both tasks and subtasks, relatively little attention has been focused on characterizing actions. However, actions are critical to the disclosed approach to capturing insight provenance since they represent the most basic, meaningful user analytic steps from which higher-level user tasks and sub-tasks can be inferred. An action taxonomy 300 is discussed further below in conjunction with FIG. 3.

Events: The fourth and lowest tier in the exemplary characterization is the event tier. An event Ei represents a low-level user interaction event which, in isolation, typically has little semantic value. This is in contrast to the three previous tiers (tasks, sub-tasks, and actions) all of which had rich semantic connotations. Returning to the example scenario, action A4 might consist of several low-level user events:

E1: mouse-drag to select all companies to be sorted

E2: mouse-right-click to select open a popup menu

E3: menu-select to choose “Sort” from a list of menu options

E3 . . . E8: keyboard-events to set sorting parameters (e.g., choosing ‘price change’ as the property to sort and the selecting the sorting order)

E9: mouse-click to submit the entered sorting parameters

Characterization of the Action Tier

The above-described action tier characterizes visual analytic activity and combines two important properties. First, actions 140 are domain independent, making them applicable to a broad range of user analytic tasks and applications. Second, actions 140 represent meaningful units of user activity with well-defined semantics. Therefore, if a visual analytic system is designed to explicitly support user behavior in terms of actions, it can easily capture a semantic record of a user's activity without using domain knowledge or tool-specific heuristics based on low-level interaction events.

A user action representation is described in the following sub-section that captures its main properties. Then, based on that representation, an action taxonomy is described in conjunction with FIG. 3 that categorizes a set of common actions identified during observations of visual analytic activity. This taxonomy can be used to define a representation that may be employed to semi-automatically infer how actions combine to satisfy higher-level sub-tasks.

1. Action Representation

An action 140 corresponds to an atomic and semantic analytic step performed by a user with a visual analytic system. A representation should therefore capture both (1) the general semantic properties of an action, and (2) the parameters that specify the particulars of an individual action instance. To satisfy this criteria, an action 140 is represented in an exemplary implementation with the following tuple:

Action=<Type, Intent, Parameters> (1)

The Type attribute defines a unique semantic signature for each action 140. For example, Zoom and Pan, which have unique semantic connotations, are both action types. Intent represents the primary user intention for invoking the specific action type. For example, both Zoom and Pan actions 140 correspond to users' intention to change the visual presentation of data. Finally, an action's Parameters define the functional scope of an action 140 and include the values required by a system to implement the action 140. For example, a Query action has a set of parameters that enumerates the main data concepts and data constraints that are required in formulate executable query statements (e.g., SQL).

The exemplary action representation is invariant to the underlying visual metaphor which supports it. For example, users can Zoom in with a timeline just as they Zoom in on a map. In both cases, the user's action has the same intent and type. Therefore, both Zooms are considered semantically equivalent.

Similarly, the exemplary action representation is independent of the underlying interaction events used to initiate an action. For example, Google Maps provides three distinct user interaction techniques for zooming in. Users can (1) double click on the map, (2) drag a zoom slider, or (3) click on a “plus” button. All three gestures are semantically equivalent and can be represented by the same action 140.

2. Catalog of Actions

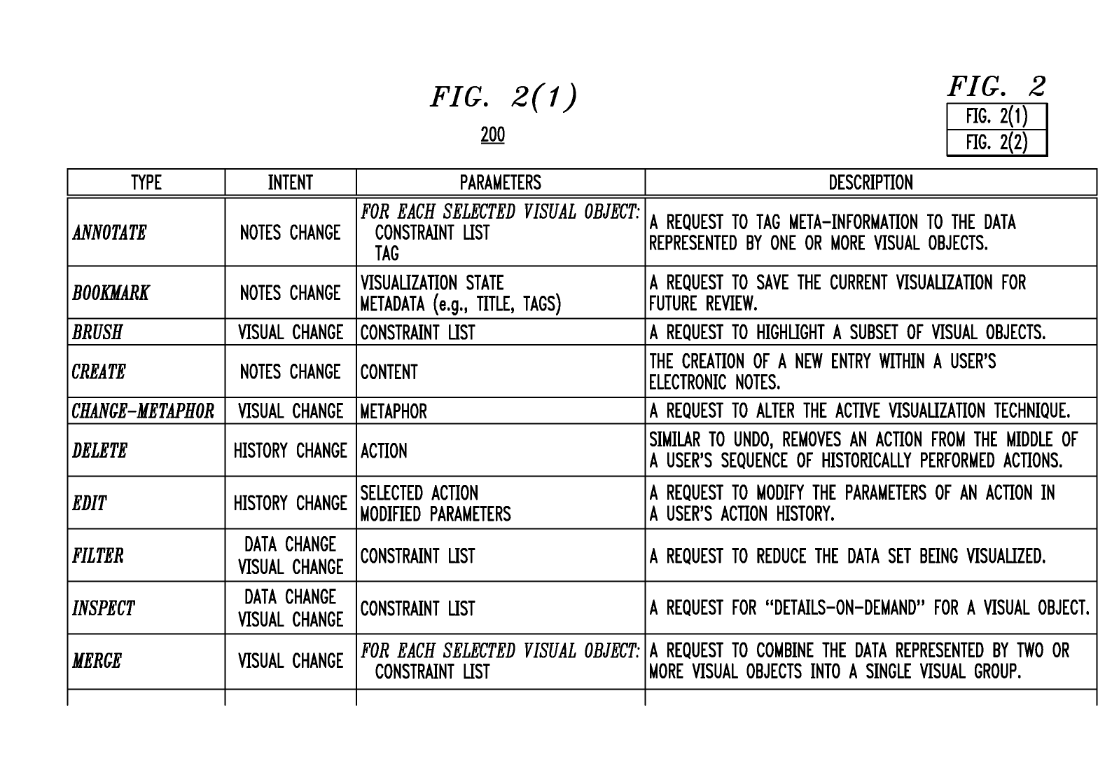

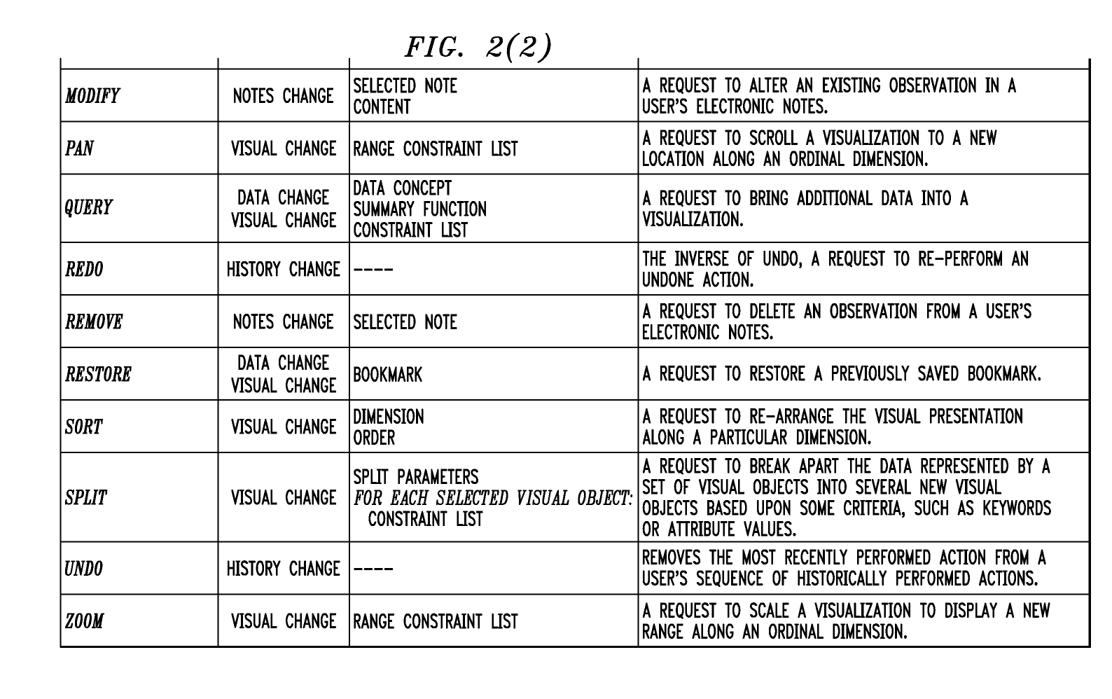

Using the exemplary action representation, several visual analytic systems were surveyed and a catalog of common actions was developed which is used to build an action taxonomy. FIG. 2 is a sample table 200 summarizing a number of exemplary distinct action types. For each action 140, the table 200 includes a formal definition (type, intent, and parameters) as well as a brief description. Each action 140 is described using one or more intents based on the primary user motivation. Four distinct intents are used in the exemplary embodiment: (1) data change, (2) visual change, (3) notes change, and (4) history change.

The list of actions 140 in table 200 represents a union of the actions that were identified across a number of exemplary systems. No single system supported the entire set of actions. Moreover, the action catalog is not comprehensive enough to represent every potentially possible action in all systems. However, the exemplary catalog captures commonly employed user actions supported by a range of visual analytic tools.

The actions 140 in this catalog 200 serve two purposes. First, the action definitions are used to motivate the structure of an action taxonomy discussed below in conjunction with FIG. 3. Second, the list of actions types provides a common vocabulary for describing the basic semantic functions within a visual analytic system.

Action Taxonomy

FIG. 3 illustrates an exemplary taxonomy 300 for classifying user actions 140. As shown in FIG. 3, the exemplary taxonomy 300 comprises three classes of actions, namely, exploration actions 310, insight actions 320 and meta actions 330. As discussed hereinafter, the classes 310, 320, 330 are used as the basis for inferring higher-level sub-tasks from a sequence of user performed actions. In addition, the taxonomy 300 serves as a guideline for others to expand the set of actions within the characterization.

As shown in FIG. 3, within each class 310, 320, 330, actions can optionally be grouped into sub-categories, such as data exploration and visual exploration within the exploration action class 310, based on their semantics. Each action category is described hereinafter with examples to elaborate key differences.

1. Exploration Actions 310

Exploration actions 310 are performed as users access and explore data in search of new insights. In terms of intent, all actions are classified with a data change and/or visual change intention as exploration actions. Most actions fall into this category, including Query, Filter, Pan and Zoom. Exploration actions 310 are further categorized into two sub-categories: visual exploration actions and data exploration actions.

Visual exploration actions, such as Sort and Change-Metaphor, are actions where the primary user intention is to change the visual presentation of information that is already being presented to the user. For this reason, exploration actions 310 whose only intent is visual change fall into this category. For example, the Sort action is primarily a request by the user to view the data elements in a data set (e.g., shipments) in a certain order (e.g., ascending order) by a particular data dimension (e.g., shipment arrival date). Similarly, the Change-Metaphor action is primarily intended by a user to change the view of currently presented information (e.g., a map-based display) to an alternative view (e.g., a timeline display).

In contrast, data exploration actions are those actions 140 in which the user intends to change the current data that is under investigation. Any exploration action with a data change intent falls into this category, such as traditional data inquiry behaviors Query and Filter.

The exemplary classification of data and visual exploration actions is based on the user's primary intention, not the eventual system response. In practice, exploration actions 310 in both sub-categories can result in a system response that will modify both the data being viewed and the visual presentation of the data. To illustrate this point, we describe two exploration actions 310 in detail: Query, and Split.

Query: A Query action represents a user's request to bring a specific data set into a visualization. The definition of this action includes three key query parameters: a data concept, a list of constraints, and a summary function. Data concept defines what type of data entities a user is interested in. For example, in a real-estate domain, there may be multiple data concepts including houses, cities, and schools. The constraint list defines the desired data entity properties. Finally, the summary function describes how the matching data should be summarized. For example, common summary functions include Enumerate, Count, and Average.

As captured by the parameters of a Query action, the primary user intent is to change the set of data under analysis. This makes Query a data exploration action. In practice, however, a user's Query often results in changes to both the data set and visual presentation.

Split: The Split action represents a user's request to re-cluster the data represented by a selected set of visual objects based on certain criteria, such as attribute values. The definition of Split has two key parameters. First, split parameters are used as the criteria for re-clustering. Second, for each selected visual object to be split, a constraint list is provided to define the scope of the action.

As the parameters of the Split action indicate, the primary user intent is to change the visual presentation without altering the underlying set of data itself. This makes Split a view exploration action. For example, using a temporal analysis tool, a user may perform a split action on calendar data. A single summary timeline may be split into five smaller timelines, one for each person. However, while the user's intent is simply to change his or her view, the timeline tool performs an additional background query to gather the personnel data needed to perform the required clustering.

2. Insight Actions 320

Insight actions 320 are performed by users as they discover or manipulate the insights obtained over the course of an analysis. A user's insights can be recorded, for example, as free-form notes or lists of visualization bookmarks. All actions are classified with the notes change intent as insight actions.

Based on the parameters of an insight action 320, they are further classified into two categories: visual insight actions and knowledge insight actions, as shown in FIG. 3. Visual insight actions are those actions whose parameters explicitly reference objects within a visualization, such as Annotate and Bookmark. In these cases, users are explicitly marking visual objects (or entire visualizations) as related to their derived insights.

In contrast, knowledge insight actions relate to the expression and manipulation of new knowledge created by a user as the result of knowledge synthesis. This second category represents insight actions that have no direct reference to visual objects, such as Create. Knowledge insight actions are typically found in visual analytic systems that have a note taking or knowledge management component.

3. Meta Actions 330

The third class in the exemplary taxonomy 300 is meta actions 330. These actions, such as Undo and Redo, operate neither on the data set nor the visual presentation, but rather on the user's action history itself. In terms of intent, this class contains all actions with the history change intent.

Meta actions 330 are important in part because they help distill the units of user activity that should constitute an action. For example, a user would not undo a single click, but may wish to undo a Filter or Zoom. In formulating a catalog of actions, each action is generally defined at this “undo” granularity.

Action-Based Sub-Task Representation

Embodiments of the present invention employ a representation that captures how multiple actions combine to signal the accomplishment of a sub-task. A sub-task representation can be developed based on the observation that users perform sub-tasks in two distinct phases: an exploration phase followed by an insight phase. In terms of the action taxonomy 300, a user will accomplish a sub-task using a combination of exploration actions followed by a combination of insight actions. This pattern is referred to herein as a trail.

For example, assume that Bob from the sample scenario has just recorded a visualization bookmark in his notes to show that internet companies trade at a higher price-to-earnings ratio compared to other market sectors. To get to that point, Bob performed a series of actions 140: Query for financial stocks, Split by sector, Sort by price-to-earnings ratio, and finally a Bookmark action to record the visualization snapshot in his notes. These actions compose a trail that documents the provenance behind Bob's conclusion.

In practice, trails are typically more complicated than the four step sequence described above. Analysts often progressively chain together insights from multiple trails to satisfy specific sub-tasks. For example, Bob might retrieve an annotated set of high-growth companies to use as the starting point for a future sub-task. In these cases, trails become interconnected to document the web of insight provenance that satisfies an overall task. A trail τ can be represented using the regular expression shown in Equation 2.

τ=([Aᵢ^{Exploration}|τ]∘)_Aᵢ^{Insight} (2)

This definition, in combination with the disclosed taxonomy 300, allows a visual analytic system to detect how sequences of user performed actions combine to satisfy individual sub-tasks. Just as an insight action allows users to record what has been discovered, the automatically captured trail for each insight represents how a particular insight was generated. When paired with a user's notes, automatically extracted trails provide a comprehensive and logically meaningful model of insight provenance.

Semantics-Based Capture of Insight Provenance

In one exemplary embodiment, a semantics-based model can be employed to evaluate a user's visual analytic activity. As previously indicated, the model of user activity is referred to herein as insight provenance, because it contains the entire history and rationale of how insights are derived during a user's visual analytic process.

It has been found that one of the distinct semantic constructs observed in a user's analysis process is a logical sequence of user actions leading to an insight. This sequence of user actions is referred to as an analytic trail. Assume an exemplary user has performed three actions, Query, Filter, Query, to reach a given state. Assume further that the user then bookmarks (Bookmark) this state to save it as “Project distribution for 5 disciplines.” This sequence of four actions, Query, Filter, Query,Bookmark, becomes one of the user's analytic trails.

As this example illustrates, trails define a user's exploration path and its semantics (e.g., captured by the action types and parameters). Trails typically have a well-defined structure that can be automatically identified by the action tracker 120 (FIG. 1) using a set of rules. For example, one rule checks for certain action types, such as Bookmark or Annotate, which signal the end of a trail.

When users save their work (e.g., using an insight action such as Bookmark), the exemplary visualization analysis system 100 preserves both the final state of the visualization as well as the user's entire analytic trail. When a bookmark is later restored, the trail is restored as well. This allows a user to review the exploration context in which an insight was discovered. This feature is especially useful during collaborative tasks, allowing users to see not only what has been found, but also how.

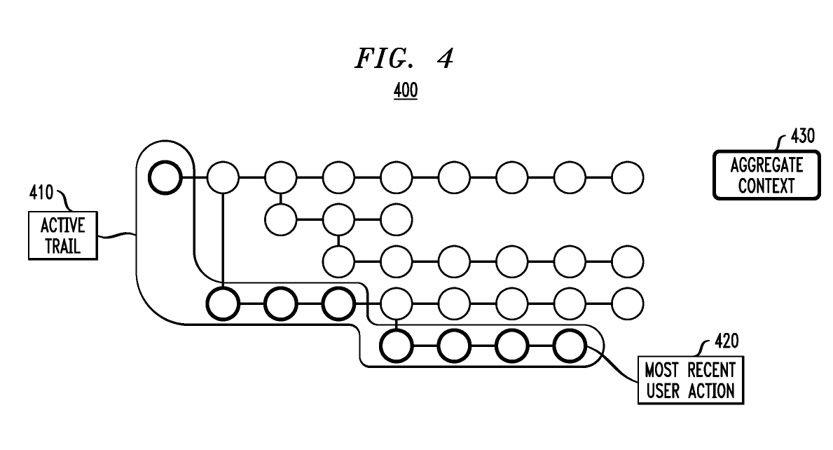

FIG. 4 is a trail graph 400 representing a user's activity. Generally, each node in the graph 400 corresponds to a single action 140. Information associated with each single action, such as action type, parameters, and system response, can be anchored to the graph 400. For example, the information associated with an exemplary filter action may comprise {Filter: <make=Honda>; Thumbnail; Presentation Info}.

A “trail” is a path through the graph 400. An “active trail” 410 connects the initial action in the graph with the user's most recent action 420. An aggregated data structure 430 stores a summary of the user's active trail, such as a summarized set of parameters generated by composing parameters from each action 140 on the user's active trail 410.

In one exemplary embodiment, the graph 400 can be built using rules. Generally, exploration actions extend trails and insight actions terminate trails. Terminated trails are persisted for future review along with insight. Meta actions can cause branches in the graph 400. Revisit actions change the focus node of a trail and follow-up actions create branches in a trail. Edit and delete actions cause new branches or other changes in the trail structure.

Graphical User Interface

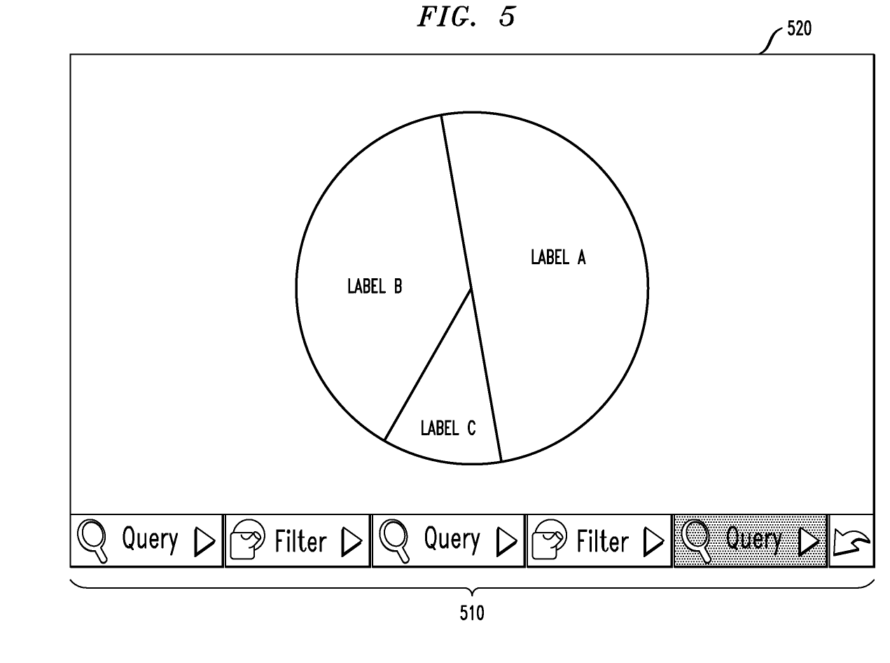

One of the main benefits of capturing action trails is to allow users to adapt their previous analysis processes to new tasks. As a user interacts with the system, the exemplary visualization analysis system 100 externalizes a user's exploration path in a history panel, discussed further below in conjunction with, for example, FIG. 5. Each time a new action is performed, the panel is updated to reflect user's ongoing analysis. Similarly, when a user re-visits a saved bookmark, the corresponding trail is restored and externalized through the history panel.

As discussed further below, the exemplary visualization analysis system 100 supports flexible manipulations of the actions in a trail. The manipulations include: Undo, Delete, Revisit, and Modify. Undo allows a user to reverse his or her most recently performed actions one by one. A user can also modify or delete any action in the trail. This allows users to quickly adapt their previously performed trails to new contexts. Revisitation allows users to return to earlier points in their analysis by changing the focus node of the active trail. When a trail is altered, the sequence of actions is essentially replayed by the visualization analysis system 100 as if it were an analytic macro whose parameters had been changed.

Furthermore, a user can jump to any action and start his or her new analysis process from there. This feature is especially powerful when combined with bookmarks. Rather than starting an analysis from scratch, a user can reload a saved trail by restoring a bookmark. The user can then select any action in the trail to use as a starting point for his or her new analysis. Alternatively, the user can re-use the entire trail and simply modify individual action parameters to meet her new needs.

Various aspects of the exemplary graphical user interface are discussed in the following subsections.

1. Maintain and Expose Trail Graph

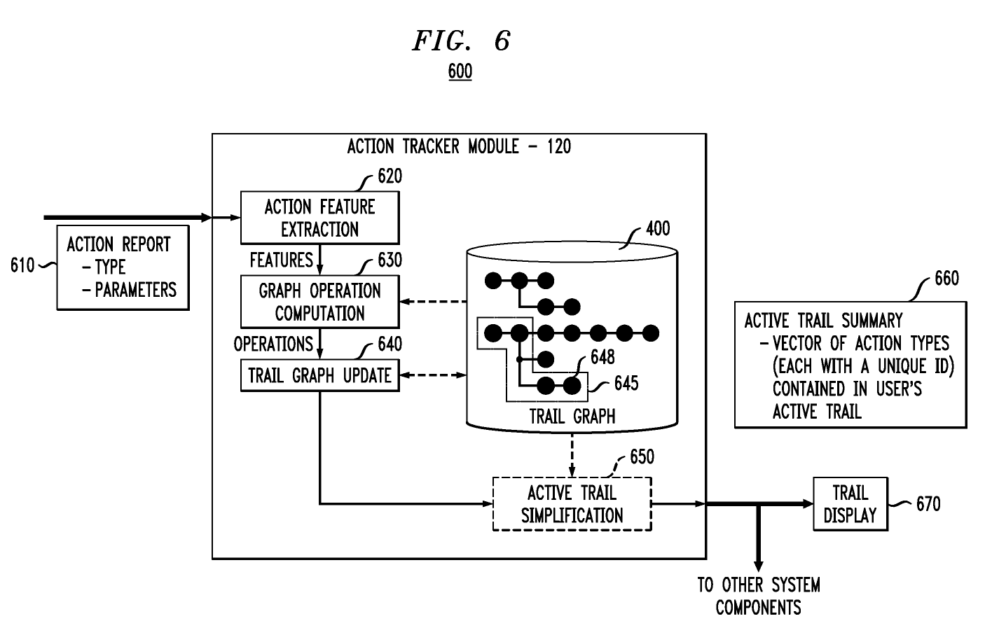

FIG. 5 is an exemplary graphical user interface 500 illustrating a user's active trail 510. Generally, the graphical user interface 500 relies upon the action tracker 120 to capture the logical structure of a user's visual analysis, referred to as a trail graph 400 (FIG. 4). The action tracker 120 maintains the graphical user interface 500 by employing an algorithm 600 discussed further below in conjunction with FIG. 6.

As shown in FIG. 5, the exemplary graphical user interface 500 presents a snapshot of the user's active trail in a window 510. Each button in the window 510 corresponds to one or more sequential nodes from the active trail 410 in the trail graph 400. A user can select a given button for additional information and a thumbnail about the node.

As users interact with the system 100, their behavior is observed by the action tracker module 120 that receives action reports as input. Based on the action report, the action tracker 120 updates the trail graph data structure and provides visibility into the data structure to the rest of the system. Each action report includes (1) an action type, and a (2) set of parameters. Respectively, these define both (1) the semantic signature of the user action (e.g., Query, Filter, Zoom), and (2) the specific parameter values that specify the particulars of an individual action instance (e.g., for a Filter action instance, the parameters could be MAKE=FORD, MODEL=TAURUS). A more detailed definition of actions can be found above in the section entitled “Characterization of the Action Tier.”

FIG. 6 is a flow chart describing an exemplary implementation of a trail graph maintenance process 600 incorporating features of the present invention. As shown in FIG. 6, the action report 610 is sent to an Action Feature Extraction component 620. The Action Feature Extraction component 620 instantiates a Trail Graph Node data structure to represent the new action and its associated features. Any features from the action report 610 are extracted and inserted into the data structure (e.g., type, parameters). In addition, other features are calculated and inserted into the data structure, including the time at which the action was reported to the action tracker module and the classification of the action type in our action taxonomy. The classifications, such as Exploration Action 310, Insight Action 320 or Meta Action 330, are shown in FIG. 3.

The Trail Graph Node data structure, which contains the extracted action features, is forwarded to a “Graph Operation Computation” phase 630 where it is examined in the context of the user's current trail graph to determine a set of operators needed to update the trail graph based on the new action. These operations include, for example, Extend, Branch, Terminate, and Remove. Each individual trail graph node has its action features translated into a list of one or more trail graph operations. This computation is performed, for example, via a set of rules that account for the specific features of the action (e.g., insight actions terminate trails as stipulated by the trail definition in equation (2)).

The Trail Graph Node and its corresponding list of trail graph operations computed during phase 630 are forwarded to a “trail graph update” stage 640. During stage 640, the trail graph operations are performed sequentially to update the trail graph data structure 400. For example, if an action 120 contains the sequence of operations [Branch, Extend], then stage 640 first creates a new branch in the trail graph 400 before appending a new node to the newly created branch to satisfy the extend operation. The new node contains references to the incoming action's data structure.

As indicated above, the user's active trail 645 corresponds to the path through the trail graph that contains the most recently performed action. The action most recently performed is marked as the “Focused Action” 648. The active trail 645 is retrieved in an optional “Active Trail Simplification” phase 650 and simplified to reduce complexity. This is done, for example, via a rule-based algorithm that contracts neighboring nodes within the trail graph 400 into single steps in the summarized trail 600. For example, if a user performs two sequential Pan actions (e.g., Pan x=5,y=4; Pan x=−1,y=1), the two actions can be combined to form one pan action (e.g., Pan x=4,y=5). Another rule used in one embodiment is a time threshold requiring a minimum amount of time to have elapsed before simplification 660 can occur to ensure that recent actions are not simplified too aggressively.

The summary 660 of the trail graph's active trail 645, possibly simplified if that optional step 650 is performed, is returned by the action tracker module to represent the user's current analytical path. This can be used, for example, to display a representation of the user's logical progress as shown in FIG. 5. In one embodiment, the summarized trail 660 consists of a vector of <action type, action id>pairs. In other embodiments, more or less information about the trail can be included in the summary 660.

The summarized trail 660 can be passed to a Trail Display module 670 that converts the summarized trail structure 660 into a graphical display 500 of the user's logical progress. As shown in FIG. 6, the summarized trail structure 660 can also be used by other portions of the system.

2. Interactive Trail Display

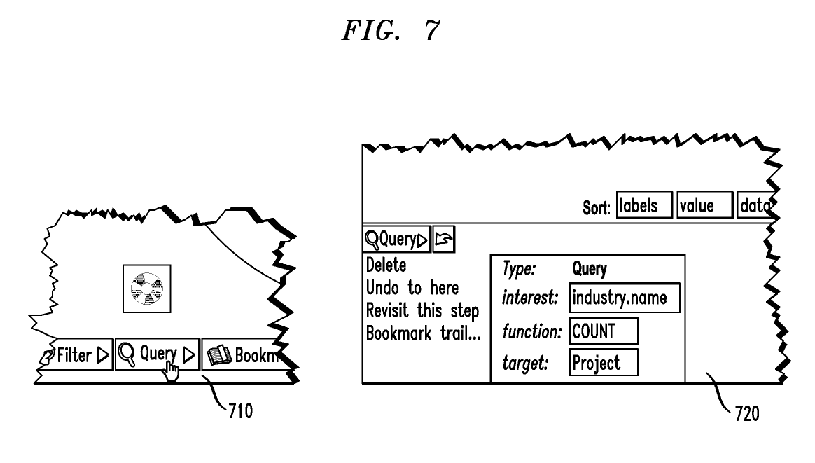

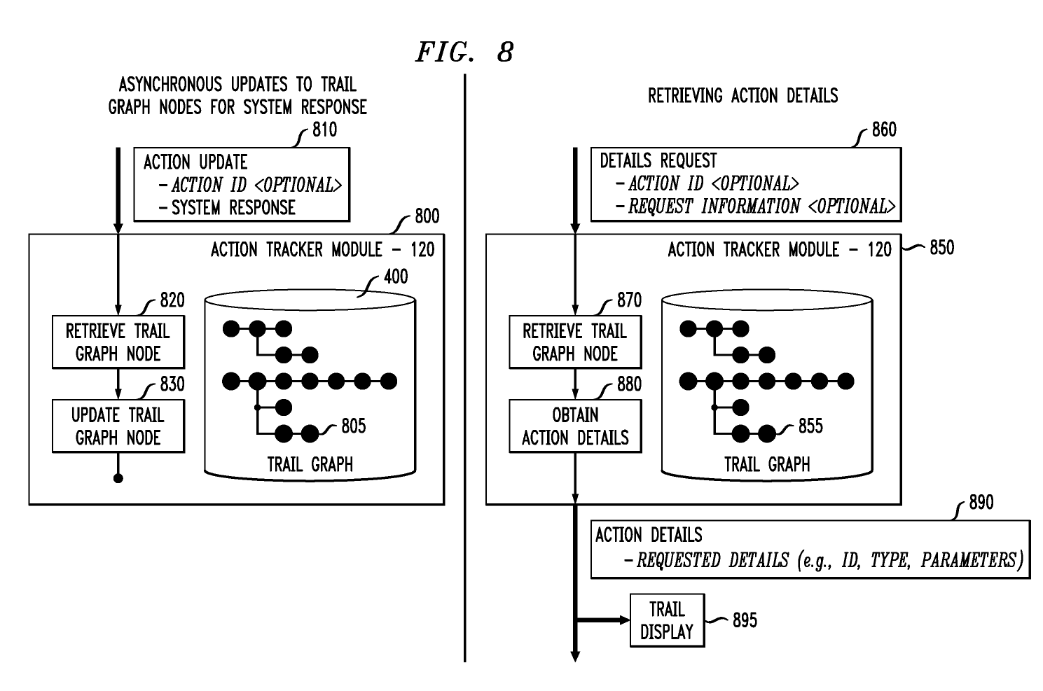

FIG. 7 is an exemplary graphical user interface 700 illustrating an interactive trail display in accordance with an aspect of the present invention. Generally, the graphical user interface 700 allows a user to select a previous step and generate a thumbnail image 710. In addition, a user can generate a pop-up window 720 with details of individual actions. The action tracker 120 maintains the interactive display 700 by employing algorithms 800, 850 discussed further below in conjunction with FIG. 8.

As shown in FIG. 8, an algorithm 800 allows asynchronous updates to trail graph nodes for system response. Again, action reports 810 (which correspond to a user's interaction with the system) may be delivered to the action tracker module 120 before the system has finished responding to the user's behavior. For example, in one embodiment in a visualization system, a Query action and its associated parameters are recorded by the action tracker 120 before the data has been graphically displayed to the user. As a result, a thumbnail of the visualization produced by the query is not available until a later point in time.

System response data, such as the thumbnail 710 in the above discussion, can therefore be added to the trail graph 400 asynchronously. This is done through an update mechanism of the action tracker module. When an update 810 is sent to the action tracker 120, an action ID is optionally supplied as a parameter. If the action ID is available, it is used to retrieve the action specified by the ID during phase 820. If an ID is not supplied, the focused action 805 is retrieved.

Once the appropriate trail graph node has been retrieved during phase 820, the retrieved node is updated during phase 830 by merging the supplied system response together with any system response information that may already be stored within the node. For example, after the system displays the results of a Query action using a visualization algorithm, a small thumbnail of the graphical display is stored via this mechanism. This is used to support the mouse-over interaction shown in FIG. 7.

As shown in FIG. 8, an algorithm 850 allows retrieval of action details. As described above, a summarized version 660 of the user's active trail is displayed visually. Depending on the embodiment, this summary can contain varying amounts of detail and typically contains only a subset of the information recorded in the trail graph data structure. Often, users will need to see more details than are contained in the summary 660. This can be accomplished by retrieving details about a specific action from the Action Tracker module 120.

The Details Request workflow 850 exposes the details for specific actions for use outside of the action tracker module 120 (e.g., for display on the user interface). When a request 860 is made for more details, it includes two optional parameters. First, an action ID can be supplied. If the action ID is available, it is used to retrieve the action specified by the ID. If an ID is not supplied, the focused action 855 is retrieved.

Once the appropriate trail graph node has been retrieved during phase 870, details 890 about the corresponding action are returned during phase 880. If the optional request information parameter is supplied, then only the requested details are returned. If no such information is provided as an input parameter, then all known details about the action are returned.

The action details 890 can be passed to the Trail Display module 895 which converts the summarized trail structure into a graphical display of the user's logical progress. The information can optionally be used by other portions of the system.

3. Semantic Undo

As shown in FIG. 6, action reports 610 arrive to the action tracker module 120 in response to user interaction with the user interface. Undo is in the “Meta Action” category 330 in the action taxonomy 300 (FIG. 3). Meta actions 330 differ from both Insight and Exploration actions 320, 310 in that rather than appending a new node to the trail graph 400, they trigger a modification of the existing trail graph structure 400 in some way.

When a user interacts with the user interface 500 to perform an Undo, an action report 610 is reported to the action tracker 120 and flows through the same process 600 discussed above in conjunction with FIG. 6. One of the parameters of the undo action includes the action ID of the location to which the user wishes to undo. The graph operation computation module 630 calculates the correct sequence of Delete operations required to revert the trail graph to the desired point in the user's trail. These operations are then performed in the trail graph update component 640 to execute the undo. The resulting trail is optionally simplified at stage 650 and a summary 660 is returned for use in the trail display. In addition, the altered trail can be used to drive other components of the system such as the query and visualization components which update the dataset and visual presentation to display the result.

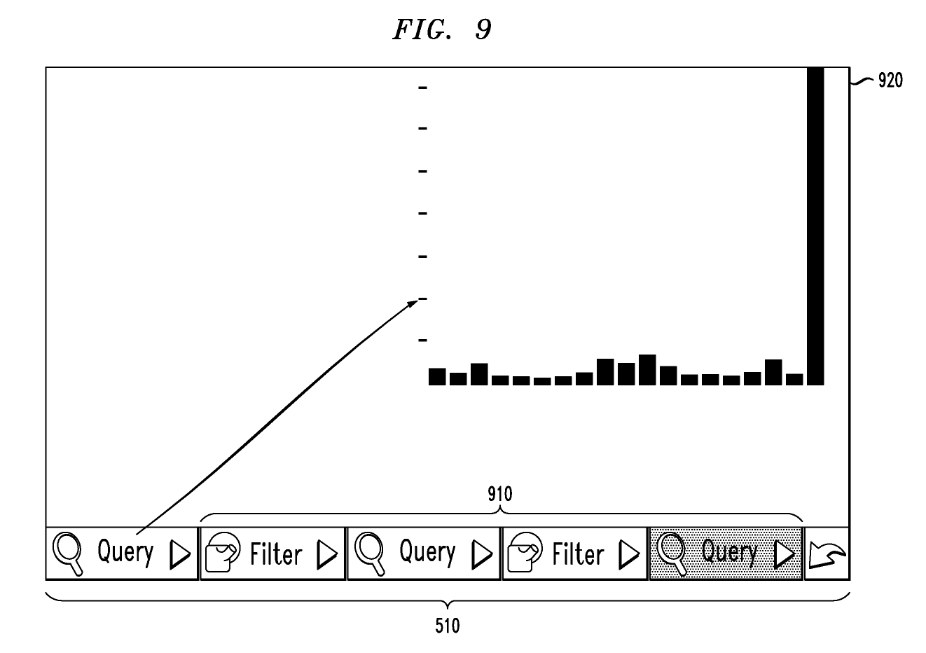

FIG. 9 is a graphical user interface 900 illustrating an undo functionality in accordance with an embodiment of the present invention. As shown in FIG. 9, the user's active trail 510 (from FIG. 5) is presented to the user. Assume that the user selects the final four actions 910 in the trail 510 and indicates an “undo” operation for the selected actions. An aspect of the present invention semantically undoes one or more steps performed on a variety of different visualizations and components. As shown in FIG. 9, the undo of four steps 910 includes a transition to a previous visualization type 920 and a change of query parameters, as appropriate.

4. Revisiting Earlier States

As shown in FIG. 6, action reports 610 arrive to the action tracker module 120 in response to user interaction with the user interface. Revisit is in the “Meta Action” category 330 in the action taxonomy 300 (FIG. 3). In response to a revisit action report 610, the trail graph update module 640 (FIG. 6) changes the focused action within the trail to the node that maps to the action ID provided by the parameters of the Revisit action. For example, assume the active trail has four actions and, the focused node is the fourth and final point in the active trail. If the user chooses to revisit the second node on that trail, the focused action is moved to the earlier position and a corresponding thumbnail can be presented.

The active trail summary 660 reflects this change and allows the focused node to be displayed properly to the user. In addition, the shortened segment of the trail (from the start to the focal point) can be used to drive other components of the system such as the query and visualization components which update the dataset and visual presentation to display the result.

5. Modification of Actions

Modify is in the “Meta Action” category 330 in the action taxonomy 300 (FIG. 3). Users can modify parameters of actions performed earlier in their analysis by interacting with the user interface. In response to a modify action report 610, the trail graph update module 640 (FIG. 6) recognizes the user's intent to change a particular action's parameters. In response, the correct operations are selected and the trail graph update module 640 alters the data structure as requested. For example, a user can modify a Filter:<make=Ford,model=Taurus> action to become Filter:<make=Ford,model=Explorer> in order to change their trail to explore data for a different kind of Ford vehicle.

Once again, the active trail summary 660 reflects this change and can be displayed to the user. In addition, the altered active trail summary 660 can be used to drive other components of the system such as the query and visualization components which update the dataset and visual presentation to display the result.

6. Deletion of Actions

Deletion is in the “Meta Action” category 330 in the action taxonomy 300 (FIG. 3). Users can select individual actions from the user interface to be deleted from the trail. For example, users can delete the filter action Filter:<model=Explorer> to expand their work to cover not just Explorers, but all models.

In response to a user's interaction, an action report 610 is sent to the action tracker module 120 to signify the user's intent to delete a specific action. In response, the correct operations are selected and the trail graph update module 640 alters the data structure as requested. The active trail summary 660 reflects the changed trail which can be displayed to the user. In addition, the altered active trail summary 660 can be used to drive other components of the system such as the query and visualization components which update the dataset and visual presentation to display the result.

7. Saving a Bookmark

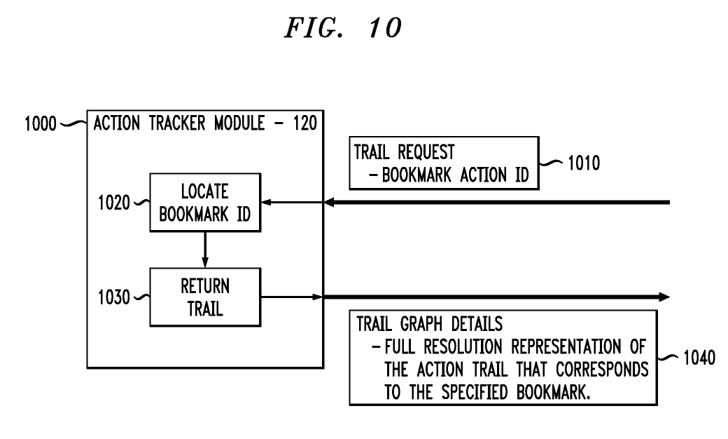

When a user creates a visualization bookmark, the visualization state is captured from the visualization module. In addition, a bookmark action 610 is reported to the action tracker 120 which updates the user's trail graph 400 according to the flow outlined in FIG. 6. Following the update to the trail graph 400, the system 100 can request a detailed representation of the trail that corresponds to the saved bookmark by executing the flow shown in FIG. 10. The trail graph details that are returned are persisted together with the visualization state.

As shown in FIG. 10, a bookmark save process 1000 initially receives a trail request 1010. Thereafter, the bookmark save process 1000 locates the bookmark ID during stage 1020 and returns the trail during stage 1030 to provide trail graph details 1040. The trail saved as insight provenance, together with a visualization bookmark. In general, the bookmark represents how an insight was discovered

8. Restoring a Bookmark

When a bookmark is restored, the trail graph details that were persisted at the time a bookmark was saved (using process 1000, FIG. 10) is passed back to the action tracker module 120, using a bookmark restore process 1100.

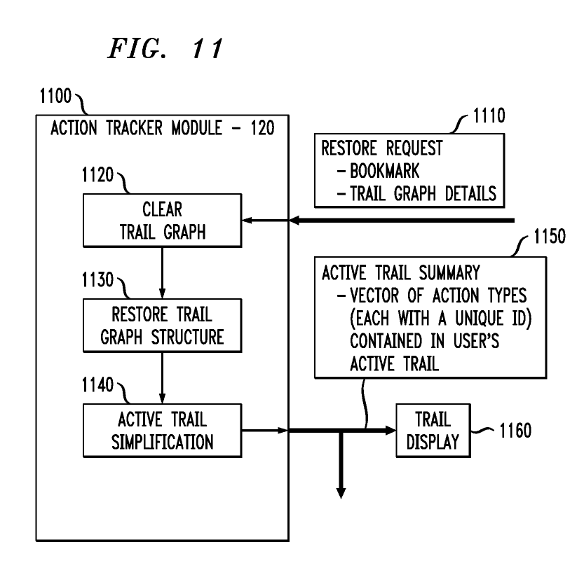

As shown in FIG. 11, the bookmark restore process 1100 receives a restore request 1110. The bookmark restore process 1100 first clears any existing trail graph during phase 1120 and replaces it with the graph that is associated with the bookmark to be restored during phase 1130. Optionally, trail simplification is performed during phase 1140, as in FIG. 6. The active trail summary 1150 can be displayed to the user during phase 1150. In this manner, the desired trail is restored along with the appropriate visualization.

The summary 1150 of the trail graph's active trail (possibly simplified if that optional step 1140 is performed), is returned by the action tracker module to represent the user's current analytical path. The summarized trail 660 can be passed to the Trail Display module 1150 which converts the summarized trail structure 660 into a graphical display of the user's logical progress.

### CONCLUSION

While a number of figures show an exemplary sequence of steps, it is also an embodiment of the present invention that the sequence may be varied. Various permutations of the algorithm are contemplated as alternate embodiments of the invention.

While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware. Such software may be employed in, for example, a digital signal processor, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

The visualization analysis system 100 comprises memory and a processor that can implement the processes of the present invention. Generally, the memory configures the processor to implement the visual recommendation processes described herein. The memory could be distributed or local and the processor could be distributed or singular. The memory could be implemented as an electrical, magnetic or optical memory, or any combination of these or other types of storage devices. It should be noted that each distributed processor that makes up the processor generally contains its own addressable memory space. It should also be noted that some or all of visualization analysis system 100 can be incorporated into a personal computer, laptop computer, handheld computing device, application-specific circuit or general-use integrated circuit.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

What is claimed is:

1. A method for maintaining a logical record of visual analytic activity of a user by recording one or more visual analytic actions, comprising:
determining a set of action features of said one or more visual analytic actions and recording said set of action features within a data structure;
calculating a set of operations required to update said logical record based on said determined features; and
updating said logical record based on said calculated operations.

2. The method of claim 1, further comprising the step of classifying each of said visual analytic actions using a predefined action taxonomy and recording other action features into a data structure.

3. The method of claim 1, further comprising the step of analyzing one or more of said data structure and said logical record of visual analytic activity to determine said set of operations required to update the logical record of visual analytic activity to reflect new user activity.

4. The method of claim 1, wherein said logical record of visual analytic activity comprises a trail graph that represents one or more possibly interconnected analytical paths of said user.

5. The method of claim 4, further comprising the step of updating said trail graph using said set of operations.

6. The method of claim 4, further comprising the step of reducing a complexity of said trail graph or a portion thereof.

7. The method of claim 6, further comprising the step of contracting a plurality of neighboring nodes in said trail graph into a single node.

8. The method of claim 4, wherein said trail graph represents how one or more insights were generated.

9. The method of claim 8, wherein said trail graph comprises a set of trails, each of said trails being a potentially recursive combination of exploration actions and other trails, which may or may not be terminated.

10. The method of claim 9, wherein a trail is terminated by a combination of one or more insight actions.

11. The method of claim 4, further comprising the step of presenting at least a portion of a version of said trail graph as a representation of a logical progress of said user.

12. The method of claim 1, further comprising the step of undoing one or more of said visual analytic actions.

13. The method of claim 1, further comprising the step of modifying one or more of said visual analytic actions.

14. The method of claim 1, further comprising the step of deleting one or more of said visual analytic actions.

15. The method of claim 1, further comprising the step of revisiting one or more of said visual analytic actions.

16. The method of claim 1, where at least a portion of a user's trail graph is persisted in response to an insight action together with the user action insights.

17. The method of claim 1, further comprising the step of restoring at least a portion of one or more of said analytic paths.

18. The method of claim 1, further comprising the step of providing details on one or more selected visual analytic actions.

19. An apparatus for maintaining a logical record of visual analytic activity of a user by recording one or more visual analytic actions, comprising:
a memory; and
at least one processor, coupled to the memory, operative to:
determine a set of action features of said one or more visual analytic actions;
instantiate a data structure to record said action features;
calculate a set of operations required to update said logical record based on said determined features; and
update said logical record based on said calculated operations.

20. An article of manufacture for maintaining a logical record of visual analytic activity of a user by recording one or more visual analytic actions, comprising a machine readable storage medium containing one or more programs which when executed implement the steps of:
determining a set of action features of said one or more visual analytic actions;
instantiating a data structure to record said action features;
calculating a set of operations required to update said logical record based on said determined features; and
updating said logical record based on said calculated operations.
